(19) United States
(12) Patent Application Publication
(10) Pub. No.: US 2006/0251808 A1
(43) Pub. Date: Nov. 9, 2006

(54) Protective coatings for pumps

(76) Inventors: Lloyd Kamo, Columbus, IN (US); Dorsaf Saad, Columbus, IN (US); Philipe Saad, Columbus, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/115,796

(22) Filed: May 3, 2005

(51) Int. Cl. B05D 7/22; F04D 29/44

(52) U.S. Cl. 427/230; 415/206

(57) ABSTRACT

The impellor, housing, flow channels, inlet and outlet flow passages of a pump used to pump a highly abrasive liquid at high volume. The flow surfaces are prepared, a primer is applied, and polyurea is applied on top of the primer to provide a protective coating rivaling extremely hard surfaces. The coating thus applied has at least the durability of expensive-to-apply hard coatings such as tungsten carbide, and siloxirane ceramic and ceramic metal filled epoxies. In addition, it minimizes the occurrence of cavitation within the pump housing, flow channels and passages.

### FIELD OF THE INVENTION

The present invention relates to pumps and more specifically, high-capacity pumps used to pump water for irrigation and other purposes.

### BACKGROUND OF THE INVENTION

In mankind's development of agricultural and urban areas, water has been a critical element. Water is used for agricultural purposes as well as human and animal needs. Nowhere is this more evident than in China where vast areas must be developed using irrigation systems much like the development in the United States in the last century. One of the key rivers in China is the Yellow River. It is so named because of its color, caused by a significant sand content. The silt content of this river is the highest in the world of the major rivers as shown in the following table:

| River | Length (km) | Silt Content (kg/m³) |
|---|---|---|
| Nile | 6670 | 0.00 |
| Amazon | 6570 | 0.14 |
| Yangtze | 6300 | 0.49 |
| Mississippi | 5970 | 0.36 |
| Yenisei | 5870 | 0.02 |
| Yellow River | 5464 | 22.04 |

Sand is a remarkably abrasive material and is used to remove material from underlying structure. When the Yellow River material is pumped, the abrasive sand particles continue to act on the pumping surface in much the same way that sand is purposely used to remove surface material such as paint and oxidation particles. In the Yellow River valley, the microstructure of the Yellow River sand has an average grain size of 0.29 microns. This particle size is significantly smaller than average sand. Instead of being less abrasive, it is much more so and, compared to other major rivers in the world, the Yellow River provides one of the most highly abrasive environments.

When irrigation pumps are designed to pump massive amounts of liquid water, they are, generally speaking, centrifugal pumps. A typical capacity of such a pump would be roughly 2000 usgpm to 180,000 usgpm. Also of importance is the flow velocity of the water containing the fine sand or silt particles. Pumps used to transfer such large volumes of water typically have a water flow velocity of not less than 50 meters/sec. The combined speed and volume of this water containing abrasive particles can erode stainless steel castings away in less than 2 months. Without any special form of treatment, a pump operating under these conditions generally lasts for no more than 2 months.

In order to extend the life of pumps of this type, the previous approach has been to apply hard materials, such as tungsten carbide, to the surfaces. This material, which in many cases is used in cutting tools, has an extraordinarily tough surface. Nonetheless, the tungsten carbide generally lasts for no more than eight months in this extreme environment.

Although the tungsten carbide, because of its hardness, resists abrasion, it is susceptible to cavitation. Cavitation is a phenomena where localized pressure in a hydrodynamic flow falls below the vapor pressure of the liquid being pumped. The result is the creation of vapor and air bubbles along the surface of the flow channel or passages. When these bubbles collapse, water rushes in to fill the void and subjects the passage wall to significant high frequency pressure fluctuations causing cavitation to occur. The resulting impact upon the passage surface causes deterioration in a manner that equals the effects of abrasion from the sand content.

When the tungsten carbide has been eroded, new tungsten carbide must be applied to the pump surface. Since the application of tungsten carbide is done by either wire arc spraying, flame spraying and fusion, or High Velocity Oxygen Fuel (HVOF) spray, the restoration of the surfaces becomes extremely complicated and expensive. In either case, the pump must be taken to a factory or techniques developed to reapply the tungsten carbide in situ. In situ reapplication of the coating becomes more complicated because the material thus applied must be directed generally toward the surface at right angles. When the impellor for the pump is a shrouded impellor having closed passages, the application of the tungsten carbide traditionally applied at right angles has to be done in extremely confined circumstances. Of the methods used for application of tungsten carbide, methods that do not allow a tool to be positioned at right angles to the surface such as needed for passages provide less than optimal application of the tungsten carbide for such passages.

Thus, there exists a need in the art for a material that is at least as long-lived as tungsten carbide and other hard materials, but at the same time is easy to apply.

### SUMMARY

The present invention relates to a method and apparatus for protecting pumps used to deliver highly abrasive liquids. The pump liquid flow surfaces are prepared and the surfaces so prepared are coated with a polyurea coating.

In a preferred embodiment of the invention, the coating is applied at moderate temperature so as to enable in situ application.

### BRIEF DESCRIPTION OF THE DRAWINGS

FIG. 1 is a perspective view of an impeller showing flow channels coated in accordance with the present invention and a portion of the flow channels with the coating partially removed to illustrate an intermediate step in the coating process.

FIG. 2 is a perspective view of a back-to-back impeller showing fragmentary views of associated flow channels.

### DESCRIPTION OF THE SELECTED EMBODIMENT

For the purposes of promoting an understanding of the principles of the invention, reference will now be made to the embodiments illustrated herein and specific language will be used to describe the same. It will nevertheless be understood that no limitation of the scope of the invention is thereby intended. Any alterations and further modifications in the described processes, systems or devices, and any further applications of the principles of the invention as described herein, are contemplated as would normally occur to one skilled in the art to which the invention relates.

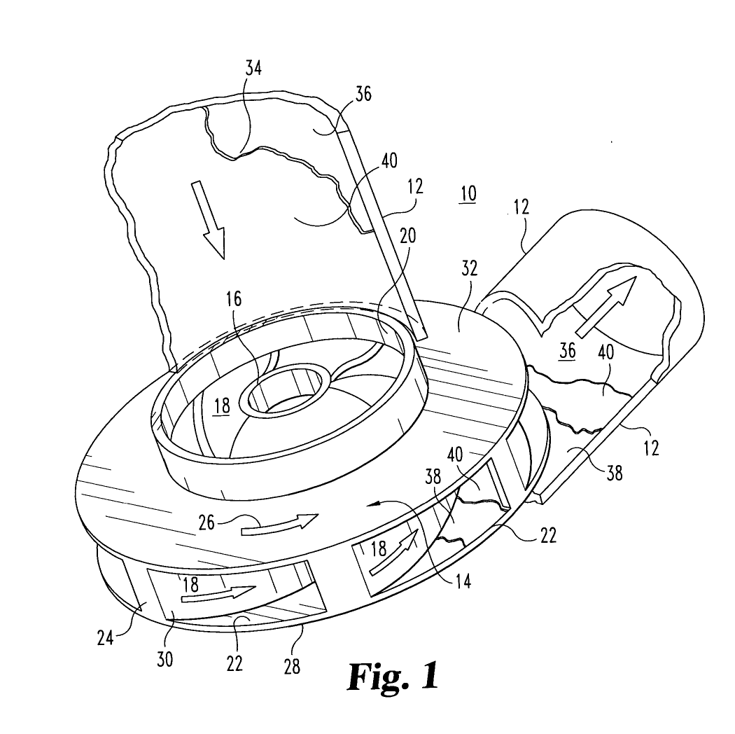

Referring to FIG. 1, there is shown a pump assembly 10 comprising a housing 12 (only a portion of which is shown to simplify the understanding of the present invention). The pump housing 12 has an impeller 14 supported and journaled about a shaft extending through central opening 16. The opening 16 is appropriately fixed on a shaft which is used to power the impeller into rotation and thus pump liquid, and more specifically, water or salt water. The details of the shaft fitted into opening 16 and the details of the mechanism or motor for driving the impeller 14 are not included in order to simplify the description of the present invention. However, it should be apparent to those skilled in the art that many different forms of power may be used to rotate impeller 14. As discussed previously, the pump 10 is designed to provide high rates of flow of liquid. This is generally above 2000 usgpm to approximately 180,000 usgpm. The pump impeller 14 has a plurality of flow channels indicated by arrows 18. The flow channels 18 begin at an axially directed central annular inlet 20 and extend in scroll-like fashion to peripheral exits 22 located around the circumference 24 of impeller 14. As shown herein, the impeller 14 rotates in a counter-clockwise direction indicated by arrow 26. Liquid passing into inlet 20 of impeller 14 passes into each flow channel 18 and is turned and accelerated radially outward to the outlets 22 around the circumference 24. Impeller 14 has a back plate 28 and vanes 30 extending generally at a right angle so as to form the flow passages 18. Impeller 14 also has a shroud 32 making the impeller one that is known in the field as a shrouded impeller. It should be apparent, however, that the benefits of the present invention can be applied to shrouded as well as unshrouded impellers with the elimination of shroud 32. The flow of liquid to impeller 14 passes through a passage 34 formed in housing 12 and opening into inlet 20 of impeller 14. Housing 12 also has an outlet chamber 36 also formed in housing 12. Outlet chamber 36 may be in the form of a volute for efficient pumping of flow through the passages. Outlet chamber 36 then connects to distribution conduits for purposes like irrigation and other appropriate water utilizing purposes.

As discussed previously, the pump 10 operates in a challenging environment for two reasons. The first is that there is a significant flow of liquid for pumping purposes. The second is that the abrasive content of the liquid so being pumped is extraordinarily high. With this set of extremely adverse circumstances, the flow channels 18 and/or flow passages 34 and 36 are coated in accordance with the present invention to provide surprising durability that rivals previous attempts at coating these channels and passages using hardened material like tungsten carbide.

In order to practice the invention, flow channels 18, and passages 34 and 36 are appropriately prepared. The surface is prepared by making sure all grease or oils are removed. Once the surface is clean and dry, it is grit blasted using 60 grit or coarser sand at 100 to 125--psig air pressure. It is important that all contaminants be removed from the surface to be coated, including previous remnants of epoxy primer and polyurea, if the surfaces are to be re-coated. For steel, iron, or galvanized material, the surfaces are abrasive blasted with 40 to 70 micron size clean Al₂O₃ grit at a minimum 100-psi compressed air pressure. The surface should be blasted to expose clean metal surface. It should be noted that if the pump and flow surfaces are to be re-coated that appropriate solvents are employed to remove traces of the previously coated material.

The surfaces so cleaned are then prepared by using a primer. As herein illustrated, the bonding primer is a two-part epoxy primer manufactured by Reltek, LLC. It consists of a proprietary bisphenol-A resin and cycloaliphatic amine hardener which are mixed thoroughly until the resultant mix appears to be of smooth and uniform consistency. This can be done either by hand or through a commercially available static mixing nozzle. Application of the epoxy primer is achieved by commercially available adhesive coating systems available by manufacturers such as TAH Industries. The primer can also be applied by brush or roller using short to medium nap roller. The epoxy primer is cured according to the following table:

| Temperature Range (° C.) | Cure Time (hours) |
|---|---|
| 10-15 | 12-18 |
| 21-27 | 6-10 |
| 32-38 | 3-5 |

Full cure of the epoxy primer is achieved after five days.

This primer is applied to the metal surfaces and it creates a surface that promotes chemical cross-linking of the molecules between the primer and the material to be applied to the primer. For the maximum cross-linking to be achieved, the subsequent material is applied before the primer is fully cured. Total curing of the primer before application of the polyurea will not enable significant cross-linking to occur between the primer and protective polyurea finish coat. The primer can be applied by brushing or spraying (previously noted) as needed to obtain a relatively thin coat of approximately 0.1 mm or less.

Alternatively, the surface could be primed with a solvent-based primer that ensures all available surface of the metal is available for cross-linking. Such a primer would contain an alcohol, butanol, and toluene solvent base. Solvent based primers can be procured from a large number of manufacturers such as Sherwin Williams and PPG Industries.

Once the primer is applied, the passages so covered are coated with a 100% solids plural component polyurea. Polyurea is a class of polymers containing an amine group, however pre-polymer components may include both pure polyureas or hybrid formulations that may consist of a polyether, polytetramethyleneglycol, polyurethane or similar pre-polymer composition.

The type of polyurea that yields the best performance results on internal pump parts experiencing the noted severe particle erosion and cavitation is available from Adiabatics, Inc. The polyurea can be applied in spray form with a low pressure of around 30 to 80 psi at a range of temperatures from 20° to 150° F. Higher temperatures permit a shorter curing time. Preferably, the epoxy primer is applied with a thickness of approximately 0.1 mm and the polyurea is applied with a coating thickness of approximately 0.25 mm to 10 mm and more preferable approximately 1.5 mm to 3 mm. The typical property of polyurea elastomer is a tensile strength of up to 5,000 psi and a durometer hardness ranging from a Shore A hardness of 30 to Shore D hardness 80.

Satisfactory polyurea based polymer coatings can also be applied by commercially available high pressure plural component application equipment that can be purchased from Graco, Incorporated or Glas Craft, Incorporated. This type of equipment controls both application pressure and temperature to provide a very consistent polyurea coating that cures more rapidly than those typically applied by the low pressure equipment. The lowest achievable durometer hardness of polyurea polymer coatings applied by the high pressure equipment is typically not as soft in durometer hardness as that which can be achieved using low pressure application equipment. From test results, it is apparent that mid to upper range Shore A hardeness (60 to 70) durometer coatings outwear both the softer and harder durometer coatings for the water or saltwater pump applications. However it is not to say, satisfactory coatings cannot be achieved using the high pressure application equipment.

In FIG. 1, one of the flow channels 18 has had the material pulled back to illustrate the epoxy primer and polyurea in the flow channel 18 illustrated. The epoxy primer is designated by the reference character 38 and the polyurea designated by reference character 40. Likewise, in outlet chamber 36, the epoxy primer 38 is shown and polyurea 40 is coated over it. Similarly, intake passage 34 has the epoxy primer 38 and polyurea coating 40.

FIG. 1 illustrates the application of the invention to a single shrouded impeller. It should be apparent to those skilled in the art that the invention may be applied with equal success to an unshrouded impeller where shroud 32 and inlet 20 are removed so that the passages of flow channels 18 are formed by adjacent vanes 30 extending from hub 28. In this case, the corresponding boundary of the flow channel will be housing in which the rotor 14 is journaled with sufficiently close clearance to maintain correct hydrodynamic conditions. The present invention has equal applicability to pumps of the type that have a pair of back-to-back rotors for high capacity and velocity output.

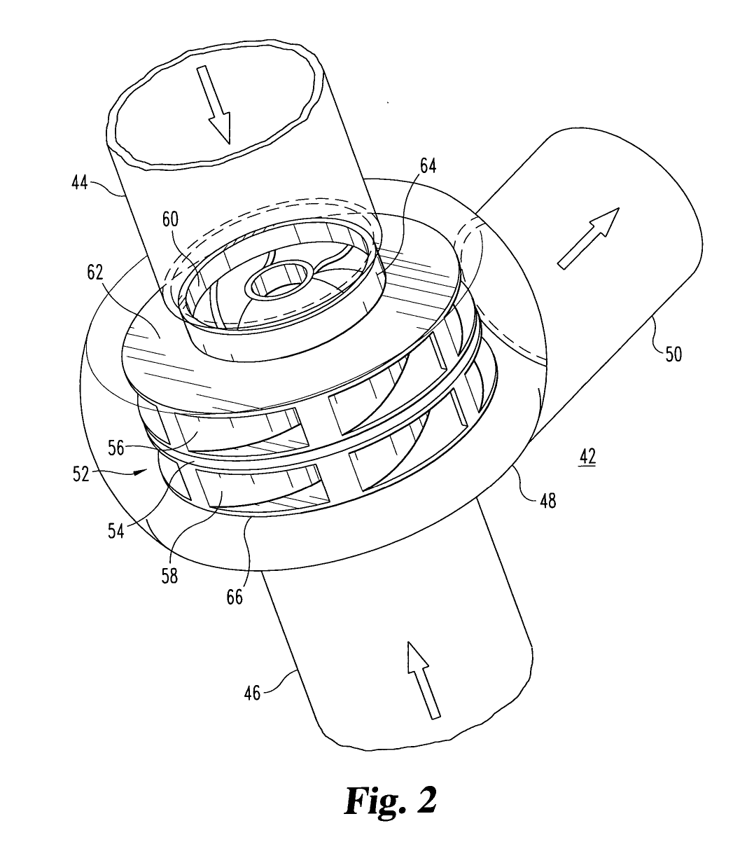

Such an arrangement is illustrated in FIG. 2. A pump assembly generally indicated by reference character 42 comprises a pair of inlet housings 44 and 46, an impeller housing 48 and common tangentially directed outlet 50. A dual back-to-back impeller assembly 52 comprises a central hub 54 having adjacent flow channels 56 and 58, each leading from their respective inlet. Inlet 60 is shown for flow channels 56. The inlet for flow channels 58 is not shown to simplify understanding of the present invention. Flow channels 56 are defined in part by the common hub 54 and a shroud 62 with an integral axial inlet section 64. Flow channels 58 are defined by the central hub 54 and a shroud 66 and associated axial inlet, also not shown.

The type of pump illustrated in FIG. 2 is particularly susceptible to erosion because of its higher capacity and higher power required to propel the liquid through the outlet. As in the case with FIG. 1, the inlet passages 44 and 46, outlet passage 50 and flow channels 56 and 58 may be selectively or unanimously coated. These surfaces are cleaned, the primer applied and finally the polyurea is applied.

Polyurea is not a waterproof material. Polyurea is not specified for long-term liquid application since water will eventually permeate and migrate to the substrate and may cause the coating to separate from the base material. In the extreme environment illustrated above where there is a high degree of abrasive material in the liquid being pumped, the polyurea protects the base material, but mechanically erodes before migration of the liquid causes the polyurea to separate from the base material. Thus, a synergism is achieved by the use of the material that would not normally be considered for such an abrasive environment.

It is also noted that the application of the resilient polyurea reduces cavitation. Cavitation is a phenomenon where because of hydrodynamic conditions, the localized vapor pressure falls to the point where the liquid is in a vapor form adjacent to the surface of the flow channels. Collapse of the bubbles thus induced causes liquid to impinge with great force in a very concentrated fashion. Cavitation additionally causes erosion of the surface of the flow channels. When the liquid being pumped has abrasive material, the cavitation effects are exacerbated. By providing a resilient polyurea material, cavitation is minimized. The relatively low temperature application of polyurea in situ restoration of the coating is extremely feasible, thus avoiding the need for removal of the pump from the work site and transport to and from a manufacturing site for application of the coating. Thus it is seen that the utilization of the polyurea offers synergistic and highly unexpected benefits in protecting a pump from the rigors from pumping an extremely abrasive content liquid, such as the Yellow River.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed:

1. A method of coating the flow channels of pumps used to pump a liquid containing a high level of abrasive material, said method comprising the steps of:
preparing the surface of at least a portion of said flow channels;
coating the flow channels so prepared with a polyurea or hybrid polyurea coating.

2. A method as claimed in claim 1 wherein the preparation of the surfaces of the flow channels comprises coating with an epoxy primer.

3. A method as claimed in claim 2 wherein the preparation of the surfaces comprises the steps of cleaning the surfaces and then abrading the surfaces.

4. A method as claimed in claim 3 wherein said abrading is performed with aluminum oxide or silica sand.

5. A method as claimed in claim 1 wherein said surfaces are selected from the group consisting of steel, stainless steel and iron material

6. A method as claimed in claim 1 wherein the polyurea coating is applied at moderate temperatures.

7. A method as claimed in claim 6 wherein the temperature of application of the polyurea coating is from 20° to 150° F.

8. A method as claimed in claim 1 wherein said pump is a shrouded centrifugal impellor and the flow channels within said impellor are coated.

9. A method as claimed in claim 1 wherein said pump is an open centrifugal impellor and the open channels are coated.

10. A method as claimed in claim 1 wherein said pump comprises a rotatable impellor and associated fixed flow channels, said coating being applied to at least one of the impellor and the fixed flow channels.

11. A method as claimed in claim 1 wherein said pump comprises a fixed housing that has a water inlet and outlet and also surrounds the rotatable impellor including associated fixed flow channels.

12. A method as claimed in claim 1 wherein said polyurea coating is over 0.25 mm thick.

13. A method as claimed in claim 11 wherein said polyurea coating is between 0.25 mm and 10 mm thick.

14. Apparatus for pumping liquid with a high abrasive count, said apparatus comprising:
a rotatable impeller having flow channels for receiving and accelerating said liquid, said flow channels being sized to provide a fluid output velocity no less than approximately 50 meters per second,
a housing in which said rotatable impeller is journaled, said housing having flow channels for receiving and discharging said liquid,
at least one of said flow channels and said flow channels having at least a portion of its surface prepared and coated with polyurea or hybrid polyurea.

15. Apparatus as claimed in claim 13 wherein the impeller is prepared and coated with polyurea or hybrid polyurea.

16. Apparatus as claimed in claim 14 wherein said impeller is un-shrouded.

17. Apparatus as claimed in claim 14 wherein said rotor is shrouded.

18. Apparatus as claimed in claim 13 wherein said impeller and channels are coated.

19. Apparatus as claimed in claim 13 wherein said preparation comprises an epoxy primer.

20. Apparatus as claimed in claim 13 wherein said polyurea coating has a thickness of between 0.25 mm and 10 mm.
